(19) United States
(12) Patent Application Publication
(10) Pub. No.: US 2009/0210162 A1
(43) Pub. Date: Aug. 20, 2009

(54) METHOD AND APPARATUS FOR ESTIMATING A PAO2 VALUE FOR A PATIENT SUBJECT TO EXTRACORPOREAL CIRCULATION

(75) Inventors: Frode Kristiansen, Kolsas (NO); Jan Olav Hogetveit, Jar (NO); Jo Roislien, Oslo (NO)

Correspondence Address: CHRISTIAN D. ABEL, ONSAGERS AS, POSTBOKS 6963 ST. OLAVS PLASS, NORWAY, N-0130, NO

(73) Assignee: RIKSHOSPITALET-RADIUMHOSPITALET HF, Oslo (NO)

(21) Appl. No.: 12/158,998

(22) PCT Filed: Dec. 27, 2006
(86) PCT No.: PCT/NO2006/000499

§ 371 Date: Sep. 10, 2008

(30) Foreign Application Priority Data
Dec. 29, 2005 (NO) 2005 6219

(51) Int. Cl. G06F 19/00

(52) U.S. Cl. 702/19

(57) ABSTRACT

The invention relates to a method and an apparatus for estimating a PₐO₂ value for a patient subject to extra corporeal circulation by means of an oxygenator. The method comprises the steps of measuring a PₑₓO₂ value in the exhaust gas of the oxygenator and calculating the estimated PₐO₂ based on the PₑₓO₂ value. Advantageously, the estimated PₐO₂ value pressure is calculated as the difference between the PₑₓO₂ value and a correction value, which is calculated in dependency of at least one measurement parameter selected from the following group: PₑₓO₂, an arterial temperature value, the blood flow through the oxygenator, venous oxygene saturation, arterial haemoglobin concentration, the fraction (FiO₂) of oxygen in the gas supplied to the oxygenator, and the gas flow supplied to the oxygenator.

### TECHNICAL FIELD

The present invention relates in general to the field of medical technology.

More specifically, the invention relates to a method and an apparatus for estimating a PₐO₂ value representing the arterial partial pressure of O₂ for a patient that is subject to extracorporeal circulation by means of an oxygenator.

### BACKGROUND OF THE INVENTION

During cardiopulmonary bypass (CPB) there is a need for reliable, accurate and instant estimates of the arterial blood O₂ tension (PₐO₂) of the patient.

Previously, the regular practice for measuring PₐO₂ during cardiopulmonary bypass involved the manual collection of intermittent blood samples, followed by a separate analysis performed by a gas analyzer. Such an approach involves a substantial delay in the acquiring of data, as well as undesirable manual steps.

Probes for inline blood gas measurements are currently in use, but they are expensive. Thus, there is a need for an alternative approach.

WO2005102163 discloses a method and an apparatus for estimating a PₐCO₂ value for a patient subject to extracorporeal circulation by means of an oxygenator, based on a measured PₑₓCO₂ value in the exhaust gas of the oxygenator and the patient's arterial blood temperature value Ta, using a temperature sensor arranged in the oxygenator. The publication does not relate to the problem of estimating the arterial partial pressure (PₐO₂) of O₂.

### SUMMARY OF THE INVENTION

An object of the present invention is to provide a method and an apparatus for indirectly estimating a value (PₐO₂) representing the arterial partial pressure of O₂ for a patient that is subject to extracorporeal circulation by means of an oxygenator.

A particular object of the present invention is to provide such a method and an apparatus which overcome the disadvantages of the prior art.

A particular object of the present invention is to provide such a method and an apparatus which provide accurate results, which is reliable, easy to operate, and which is inexpensive with regard to manufacturing and use.

A further object of the invention is to provide such a method and an apparatus which may be calibrated before use, and which also may be adjusted by the user during operation.

An additional object of the invention is to provide such a method and an apparatus which utilizes already present devices in the existing extracorporeal circulation equipment, thus avoiding further components to come in contact with the circulating blood of the patient.

The above objects and further advantages are achieved by a method and an apparatus as set forth in the appended set of claims.

Additional features and principles of the present invention will be recognized from the detailed description below.

It is to be understood that both the foregoing general description and the following detailed description are exemplary and explanatory only and not restrictive of the invention, as claimed.

### BRIEF DESCRIPTION OF THE DRAWINGS

The accompanying drawings illustrate a preferred embodiment of the invention. In the drawings,

FIG. 1 is a schematic block diagram illustrating an apparatus according to the invention included in its operating environment, and

FIG. 2 is a schematic flow chart illustrating a method according to the invention.

### DETAILED DESCRIPTION OF THE INVENTION

Reference will now be made in detail to the present invention, examples of which are illustrated in the accompanying drawings. Wherever possible, the same reference numbers will be used throughout the drawings to refer to the same or like parts.

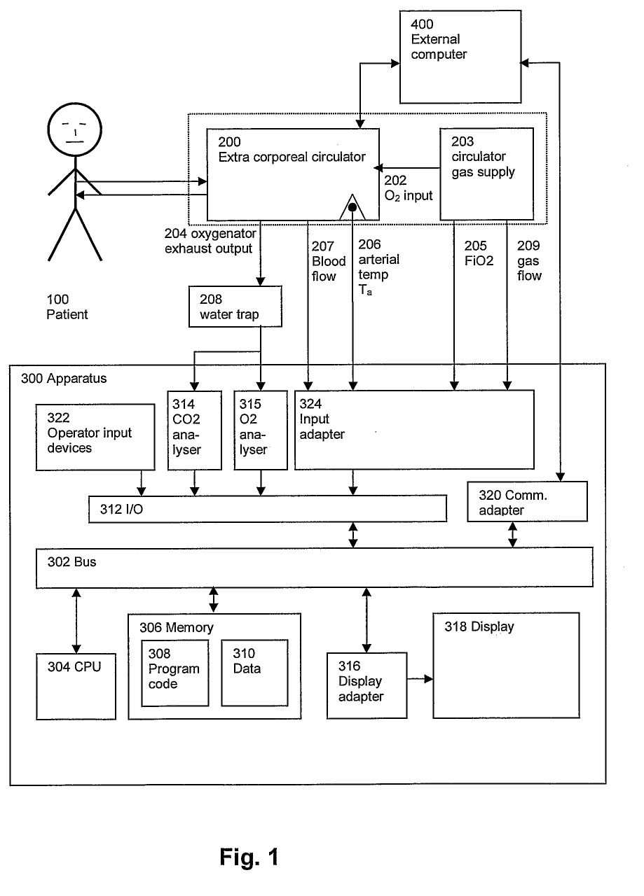

FIG. 1 is a schematic block diagram illustrating an apparatus according to the invention included in its operating environment.

A patient 100 is subject to extracorporeal circulation by means of an oxygenator incorporated in the extracorporeal circulator 200. The oxygenator in the circulator is supplied with fresh gas to its O₂ input 202, by a circulator gas supply unit 203. The extracorporeal circulator 200 and the circulator gas supply unit 203 may advantageously be integrated as one single equipment unit, as indicated with dotted line on FIG. 1. Alternatively, the gas supply unit 203 may be arranged as a separate device.

The circulator gas supply unit 203 is arranged to deliver a mixture of gases to the circulator 200. Typically, the gas consists of O₂ and N₂ in a predetermined proportion of mixture.

The gas supply unit 203 has certain characteristics which are either set by control devices in the circulator gas supply unit 203 or measured by sensors included in the gas flow line between the gas supply unit 203 and the circulator 200.

In particular, a signal 205 representing the fraction of O₂ in the gas, FiO₂ (Fraction of inspired O₂) (e.g., as a fraction 0 . . . 1 without denomination) is provided, advantageously as a set point of a control device which performs the necessary proportions of mixture in the supplied gas Alternatively, the FiO₂ signal 205 is measured by a O₂ sensor arranged in the output of the gas supply unit 203 or in the gas flow line between the gas supply unit 203 and the circulator 200.

In either case, the FiO₂ signal is supplied to an input of the input adapter 324 in the apparatus 300.

Also, a signal 209 representing the gas flow (e.g., in liters/min) is measured in the gas supply unit 203. Typically, the gas supply unit 203 has an integrated flowmeter for providing this signal. The gas flow signal is also supplied to an input of the input adapter 324 in the apparatus 300.

The illustrated apparatus 300 is an apparatus according to the present invention for estimating a PₐO₂ value representing the arterial partial pressure of O₂ for the patient 100.

The apparatus 300 comprises a measuring device 315, in particular an O₂ analyzer, for measuring a PₑₓO₂-value representing the partial pressure of O₂ in the substantially continuous and laminar flow of exhaust gas which is supplied by the oxygenator exhaust output 204.

The gas inlet of the O₂ analyzer 315 is equipped with a connector adapted for the releasable connection of a disposable tube, which is equipped with a disposable water trap 208, conveying exhaust gas from the oxygenator exhaust output 204.

The O₂ analyzer 315 comprises an O₂ sensor, which may be, e.g., based on measurements of the absorption of infrared radiation through a sample cell which contains the gas to be analyzed. The O₂ analyzer also comprises electronic circuitry for signal processing.

An example of an O₂ analyzer applicable for use with the present invention is the Square One 2025, equipped with an O₂ cell.

The apparatus 300 is designed as a processor-based instrument with a regular processor bus structure. As illustrated, a bus 302 is connected to a processing device 304, in particular a microprocessor. The bus 302 is further connected to a memory 306, comprising a program code portion 308, preferably contained in a non-volatile part of the memory 306 such as an EEPROM or a Flash memory, and a data portion 310, preferably contained in a volatile part of the memory 306 such as a RAM. Advantageously, non-executable data, such as parameters that should be maintained even if the power supply of the apparatus is switched off, may also be held in the non-volatile part of the memory 306.

The arterial temperature Tₐ is measured by means of a temperature sensor 206, in particular a thermocouple, which is inserted in the oxygenator in the extracorporeal circulator 200, and thereby arranged to measure the arterial blood temperature. The temperature sensor 206 is connected to an input of the input adapter 324, which is arranged to convert the temperature sensor signal to a digital signal, adapted to be communicated to the system bus 302 via the I/O device 312.

The extra corporeal circulator 200 is adapted to provide a blood flow signal 207 which indicates the blood flow through the circulator 200. The signal 207 may be provided by the rotational speed of a peristaltic pump in the circulator 200.

The input adapter 324 is also arranged to convert the blood flow signal 207 provided by the oxygenator to a digital signal, adapted to be communicated to the system bus 302 via the I/O device 312.

The input adapter 324 is also arranged to convert the FiO₂ signal 205 and the gas flow signal 209 provided by the gas supply unit 203 to respective digital signals, the adapted to be communicated to the system bus 302 via the I/O device 312.

The apparatus 300 advantageously further comprises a display adapter 316, connected to the bus 302 and further to a display 318. The display 318 may e.g. be an LCD display. The processing device 304 is arranged to display the estimated PₐO₂ value on the display 318.

The operator input devices 322 comprises a start button (not illustrated), arranged to be operated by an operator, such as a clinical perfusionist. The operation of the start button initiates the estimating process according to the invention.

The operator input devices 322 also advantageously comprise a stop button (not illustrated). The processing device is arranged to terminate the reiteration of the estimating process upon the operation of the stop button.

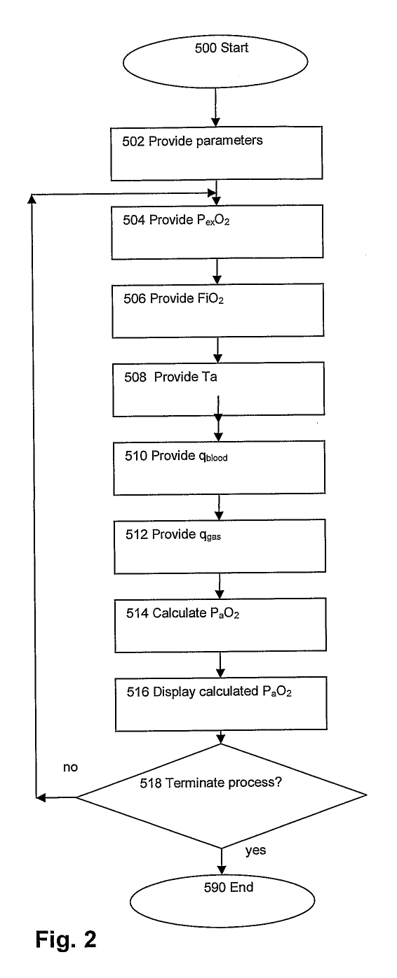

The operator input devices 322 is advantageously also arranged for setting or adjusting constants c₁, c₂, c₃, c₄, c₅, c₆. Such constants are explained further below with reference to FIG. 2. To this end, the input devices 322 are advantageously embodied as keys of a keyboard, whereby the operator may, e.g., enter numerical values.

Advantageously, the display 318 and the input devices 322 are implemented as a touch screen, wherein the input devices 322 are embodied as virtual buttons on the screen.

The input devices 322, the O₂ analyzer 315 and the input adapter measurement adapter 324 are all connected to an I/O device 312, which in turn is connected to the internal bus 302.

Optionally, a communication adapter 320 is connected to the bus 302, enabling communication between the apparatus 300 and an operatively connected, external computer 400. The external computer 400 may advantageously also be operatively connected to the extracorporeal circulating equipment 200.

The processing device 304 is arranged to execute the program code held in the program code portion 308 in the memory 306. In particular, the program code comprises instructions which cause the processor device 304 to perform the steps of the method according to the invention or to perform actions which in turn causes the apparatus 300 to perform the steps of the method according to the invention, as described below in particular with reference to FIG. 2. The actual coding of an appropriate program code implies an ordinary task for a person skilled in the art, based on the disclosure set forth in the present specification.

The processor device 304 is thus arranged to, when executing the program code 308, to calculate the estimated PₐO₂ value, dependent on the PₑₓO₂ value measured in said exhaust gas and other measurement values read by the input adapter 324.

The processing device 304 is further arranged to calculate the estimated value (PₐO₂) of the arterial partial pressure of O₂ as the difference between the measured value (PₑₓO₂) of the partial pressure of O₂ in the exhaust gas and a correction value.

Advantageously, the correction value is calculated by the processing device 304 in dependency on at least one parameter selected from the following group:
the measured value (PₑₓO₂) of the partial pressure of O₂ in the exhaust gas,
the content or fraction (FiO₂) of oxygen in the gas supplied to the oxygenator,
a temperature value (Tₐ) representing arterial blood temperature,
the blood flow through the oxygenator, and
the gas flow supplied to the oxygenator.

Advantageously, the correction value is calculated in dependency on the measured value PₑₓO₂ of the partial pressure of O₂ in the exhaust gas.

Advantageously, the correction value is also calculated in dependency on the content or fraction FiO₂ of oxygen in the gas supplied to the oxygenator.

Advantageously, the correction value is also calculated in dependency on the temperature value Tₐ representing arterial blood temperature.

Advantageously, the correction value is also calculated in dependency on the blood flow through the oxygenator.

Advantageously, the correction value is also calculated in dependency on the gas flow supplied to the oxygenator.

Tests have shown that the significance of the various measurement signals is given by the following ranking of order: PₑₓO₂, FiO₂, arterial blood temperature, blood flow and gas flow.

According to another aspect of the invention, the processing device 304 is arranged to perform the steps of measuring a value PₑₓO₂ representing the partial pressure of O₂ in the exhaust gas of the oxygenator, and to calculate the estimated value PₐO₂ of the arterial partial pressure of O₂ based on the measured value PₑₓO₂ of the partial pressure of O₂ in the exhaust gas, wherein the estimated value PₐO₂ of the arterial partial pressure of O₂ is the result of the equation

PₐO₂=PₑₓO₂−ΔPO₂ (1),

wherein ΔPO₂ is a correction value, calculated by the equation

ΔPO₂=c₁·PₑₓO₂+c₂Tₐ+c₃FiO₂+c₄q_{blood}+c₅q_{gas}+c₆ (2).

These equations are explained further with reference to FIG. 2 below.

The apparatus advantageously comprises a low pass filter, arranged for low pass filtering said PₑₓO₂ value provided by the O₂ analyzer 315. The aim of such a filter is to reduce the effects of possible rapid fluctuations in the measured PₑₓO₂ value. This filter may be implemented in several ways. For instance, it may be implemented as an analog LP filter, reducing the most rapid changes in an analog signal corresponding to the PₑₓO₂ value.

Advantageously, the LP filter is implemented digitally, as the processing device 304 is arranged to calculate an average value of a number of recently measured PₑₓO₂ values. This may again be implemented by putting each incoming PₑₓO₂ value in a FIFO queue structure with a predetermined number N of elements, and by arranging the processing device to read all elements in the FIFO data structure, and to calculate a running average value for the recent N PₑₓO₂ values. The number N may be selected by the skilled person, based on, inter alia, the sampling rate of the PₑₓO₂ readings. In an example embodiment, N=20.

The processing device is advantageously arranged to reiterate the steps of calculating estimated PₐO₂ values, each time using updated measurement values. This results in a quasi-continuous process, repeatedly providing estimated PₐO₂ values.

In a special embodiment, the apparatus 300 is also adapted for measuring PₑₓCO₂ in the exhaust gas from the oxygenator, and further arranged for estimating a PₐCO₂ value for the patient based on a measured PₑₓCO₂ value in the exhaust gas of the oxygenator and the patient's arterial blood temperature value 206. In this special embodiment, the apparatus comprises a CO₂ analyzer 314. The adaptations needed for this purpose are disclosed in the Applicant's published International Patent Application WO2005102163, which is expressly incorporated by reference.

Although not illustrated, the apparatus also comprises a power supply, a casing, connectors for gas and electric signals, operating elements et cetera. The selection and arrangement of such regular components, as well as the constructional details leading to a complete, working apparatus, may readily be performed by a person skilled in the art, without inventive efforts. The skilled person will further realize that the practical implementation of the apparatus should aim at complying with the IEC 60601-1 standard, published by the International Electrotechnical Commission (IEC).

FIG. 2 is a schematic flow chart illustrating a method according to the invention, for estimating a PₐO₂ value representing the arterial partial pressure of O₂ for a patient that is subject to extracorporeal circulation by means of an oxygenator.

The method is preferably performed as a microprocessor-implemented process, advantageously by the processor device 304 illustrated in FIG. 1.

The method starts at the initiating step 500, e.g. initiated by the operation of a start button included in the operator input devices 322 illustrated in FIG. 1.

First, in step 502, a set of constants are provided. The constants (c₁, c₂, c₃, c₄, c₅, c₆) are used in the subsequent processing. The constants are advantageously fetched from a portion of the memory 306.

The constants (c₁, c₂, c₃, c₄, c₅, c₆) may be have been generated in advance by a preceding calibration procedure, described later in this specification, and then stored in the memory. The constants may further advantageously be set or adjusted by an input device included in the operator input devices 322, as explained previously with reference to FIG. 1.

Next, in step 504, a measurement value PₑₓO₂ of the partial pressure of O₂ in the exhaust gas output 204 from the oxygenator is provided, advantageously my means of the O₂ analyzer 315.

Next, in step 506, a value of the FiO₂ signal 205 is provided, advantageously by means of the gas supply unit 203.

Next, in step 508, a measurement value of the arterial blood temperature measurement Tₐ 206 is provided, advantageously by means of the temperature sensor incorporated in the extracorporeal circulating equipment 200.

Next, in step 510, a measurement value of the blood flow signal 207 is provided, advantageously by means of the blood flow measurement device incorporated in the extracorporeal circulating equipment 200.

Next, in step 512, a measurement value of the gas flow signal 209 is provided, advantageously by means of a gas flow measurement device incorporated in the gas supply unit 203, or in the gas line between the gas supply unit 203, or in a gas inlet portion of the extra corporeal circulator 200.

It will be apparent to the skilled person that the measurement providing steps 504, 506, 508, 510 and 512 may be performed a different order or even simultaneously or concurrently, if so desired.

Advantageously, the PₑₓO₂ value is low pass filtered. This is accomplished by an additional filtering step (not illustrated) wherein the presently acquired PₑₓO₂ value is put in a FIFO queue data structure of e.g. N=20 elements. Then the average or mean value of all the FIFO elements are calculated. This leads to a LP filtered PₑₓO₂ value identical to the mean value of the last N=20 acquired instant values. This filtering reduces the effects of rapid fluctuations in the instant PₑₓO₂ values.

The above LP filtering may be omitted or replaced by an alternative filtering process. As an example, a calculating result different from the plain arithmetic mean value may be derived from the FIFO values. The resulting output may rather be a weighted average, wherein the most recent instant PₑₓO₂ values are weighted more dominantly than the less recent instant values. Other possibilities exist within the apprehension of the skilled person.

A calibration procedure for pre-generating the constants that are provided in step 502 is described in the following:

For a number of different (parameters) and preferably also for a number of different patients (e.g., 10 patients), the PₑₓO₂ values measured by the O₂ analyzer are measured and recorded. For each arterial blood temperature value Tₐ the corresponding true PₐO₂ value is also recorded, provided by manual collection of a blood sample followed by a separate analysis performed by a reference bloodgas analyzer. This leads to a multiple data set of corresponding values for temperatures, PₑₓO₂ and PₐO₂. The values for the constants (c₁, c₂, c₃, c₄, c₅, c₆) are then calculated by regular linear regression, thus establishing the set of constant values (c₁, c₂, c₃, c₄, c₅, c₆) that minimizes the overall difference between the estimated PₐO₂ value and the true PₐO₂ value.

In the calculating step 514 the estimated PₐO₂ value is established by the formula

PₐO₂=PₑₓO₂−ΔPO₂ (1)

wherein PₑₓO₂ is the preferably averaged or filtered PₑₓO₂ measurement value, and the correction term ΔPO₂ is calculated as

ΔPO₂=c₁·PₑₓO₂+c₂Tₐ+c₃FiO₂+c₄q_{blood}+c₅q_{gas}+c₆ (2)

In these equations, PₑₓO₂ is the measured value of partial pressure of O₂ in the exhaust gas of the oxygenator, Tₐ is a temperature value representing arterial blood temperature, FiO₂ is a value representing the fraction of oxygen in the gas supplied to the oxygenator, q_{blood} is the blood flow through the oxygenator, q_{gas} is the gas flow supplied to the oxygenator, and c₁, c₂, c₃, c₄, c₅, c₆ are predetermined constants.

Advantageously, c₁<0, c₂>0, c₃>0, c₄<0, c₅>0, and c₆<0, and the constants (c₁, c₂, c₃, c₄, c₅, c₆) are advantageously pre-generated by a calibration procedure and stored in a memory. Alternatively, the constants (c₁, c₂, c₃, c₄, c₅, c₆) are adjustable by the input devices 322, or they may be read from the external computer 400. The most favorable values of the constants (c₁, c₂, c₃, c₄, c₅, c₆) will probably depend on the type of oxygenator used. Calibration values of the constants (c₁, c₂, c₃, c₄, c₅, c₆) may also be recorded and supplied for downloading into a memory as constant values associated with specific equipment, in particular an oxygenator. Calibration values may also be recorded and supplied as constant values associated with a particular patient.

In the above model, the correcting term is calculated by adding weighted instantaneous values or filtered values of the respective measurement signals, forming a static, linear approach.

However, the skilled person will realize that other models for providing a correction value exist, including a dynamic approach, wherein correction terms are provided as the derivative or higher orders of derivatives of the signal values with respect to time. In such cases, a larger, corresponding number of constants are evidently necessary. Tests have however shown that a static approximation is appropriate for practical purposes.

Further, the skilled person will also realize that other models for providing a correction value include non-linear approaches, wherein correction values are provided as 2^{nd}, 3^{rd} or even higher order polynomials of the signal values (such as, e.g., the arterial temperature value). In such cases, a corresponding number of constants are evidently necessary. Tests have however shown that a linear approximation is appropriate for practical purposes.

Next, in step 516, the estimated PₐO₂ is presented on a display.

In the determining step 518 it is determined if the process is to be terminated, e.g. if stop-button included in the operator input devices 322 is activated. If this is true, the terminating step 590 is performed. Else, the process is reiterated by returning to the providing step 504.

Several modifications and adaptations of the present invention will be apparent to those skilled in the art from consideration of the specification and practice of the invention disclosed herein.

For instance, although the apparatus is illustrated as a complete instrument wherein the processing device, the display and operating devices are all included, the skilled person will readily realize that alternative embodiments also exist within the scope of the invention as defined in the claims. The apparatus may thus be, e.g., embodied as a virtual instrument operating on a general purpose computer such as a PC, executing virtual instrument software such as e.g. LabView, which is further configured in order to operate according to the present invention. LabView is a computer software product for a data acquisition and virtual instrumentation, manufactured by National Instruments Corp., which is well-known to a person skilled in the art. In this case, the computer will either include or operatively be connected to peripheral devices necessary to practice the invention, in particular the O₂ analyzer and an input port for the various measured parameters such as FiO₂, gas flow and so on. However, functions such as the operating devices or switches may effortlessly be implemented as software modules, operating in conjunction with regular computer input devices such as a keyboard and a mouse. The display 318 may correspondingly be substituted by a regular computer display.

Further, in the special embodiment mentioned above, wherein PₑₓCO₂ is also measured by a CO₂ analyzer 314, the processing device 304 is advantageously further arranged to perform a method for estimating a for estimating a PₐCO₂ value for the patient based on a measured PₑₓCO₂ value in the exhaust gas of the oxygenator and the patient's arterial blood temperature value 206. Such a method is disclosed in detailed in WO2005102163, which is expressly incorporated by reference.

In the embodiments specified by example in the detailed description above, the correction value ΔPO₂ has been calculated based on measurement signals including PₑₓO₂, FiO₂, arterial blood temperature, blood flow, and gas flow. Also, it has been suggested in an embodiment that the significance of the various measurement signals is given by the following ranking of order: PₑₓO₂, FiO₂, arterial blood temperature, blood flow and gas flow.

Other tests have shown that different measurement signals may alternatively or additionally be included in the calculation.

Such measurement signals include venous oxygen saturation, which may be measured by means of an additional blood gas analyzer configured to analyze the venous blood of the patient, and arterial haemoglobin concentration, which may be measured by means of an additional blood gas analyzer configured to analyze the arterial blood of the patient.

Tests performed by the applicant have suggested that the following order may indicate the significance of the various measurement signals (the first signal being the most significant one): PₑₓO₂, arterial blood temperature, blood flow, venous oxygen saturation, arterial haemoglobin concentration.

Thus, in an alternative embodiment of the invention, the calculation of the correcting term may be based on PₑₓO₂, arterial blood temperature, blood flow, venous oxygen saturation, and arterial haemoglobin concentration, while the gas flow and FiO₂ may be omitted or neglected.

Thus, in this alternative embodiment, c₃ and c₅ are both set to zero in the equations (1) and (2). Further in this alternative embodiment, terms representing venous oxygen saturation and arterial haemoglobin concentration are also included in the weighted sum forming the correction value and assigned corresponding appropriate coefficients that may be included in a calibration model and calculated in a calibration procedure as already specified.

In the above detailed description it has been specified that the correcting term may be calculated by a static, linear approach, i.e. as a weighted sum of instant input signals As an alternative approach, a dynamic approach has been indicated, wherein derivatives or higher order derivatives also are included in the correcting term. Also, a non-linear approach has been indicated, wherein polynomials of input signals are included in the calculation of the correcting term.

In such a non-linear approach, the incorporating of cross-terms in the correcting term has proved to be useful as to the accuracy of the resulting estimation model. This will ensure that interactions between the various input signals will influence the estimation model. Thus, the weighted sum may include terms that are products of different input signals, such as, e.g., PₑₓCO₂ multiplied by Tₐ, or blood flow multiplied by arterial haemoglobin concentration, or any other product of two measurement values selected from the group [PₑₓO₂, Tₐ, q_{blood}, venous oxygene saturation, arterial haemoglobin concentration, FiO₂, q_{gas}].

It will readily be realized that the specification of the calibration procedure for pre-generating the constants in the calculation model is still applicable although some of the input signals (such as gas flow and/or FiO₂) are substituted by other input signals (such as venous oxygen saturation and/or arterial haemoglobin concentration, or some input signals are omitted, or additional input signals are added.

The above detailed description of the invention has been presented for purpose of illustration. It is not exhaustive and does not limit the invention to the precise form disclosed. Modifications and variations are possible in light of the above teachings or may be acquired from the practicing of the invention.

1. Method for estimating a value (PₐO₂) representing the arterial partial pressure of O₂ for a patient subject to extra corporeal circulation by means of an oxygenator, the method comprising the steps of:
measuring a value (PₑₓO₂) representing the partial pressure of O₂ in the exhaust gas of the oxygenator, and
calculating the estimated value (PₐO₂) of the arterial partial pressure of O₂ based on the measured value (PₑₓO₂) of the partial pressure of O₂ in the exhaust gas, wherein said estimated value (PₐO₂) of the arterial partial pressure of O₂ is the result of the equation
PₐO₂=PₑₓO₂−ΔPO₂ (1)
wherein ΔPO₂ is a correction value, being the result of the equation
ΔPO₂=c₁·PₑₓO₂+c₂Tₐ+c₃FiO₂+c₄q_{blood}+c₅q_{gas}+c₆ (2)
wherein
PₑₓO₂ is the measured value of partial pressure of O₂ in the exhaust gas of the oxygenator,
Tₐ is a temperature value representing arterial blood temperature,
FiO₂ is a value representing the fraction of oxygen in the gas supplied to the oxygenator,
q_{blood} is the blood flow through the oxygenator,
q_{gas} is the gas flow supplied to the oxygenator, and
c₁, c₂, c₃, c₄, c₅, c₆ are predetermined constants.

2. Method according to claim 1,
wherein c₁<0, c₂>0, c₃≧0, c₄<0, c₅≧0, and c₆<0

3. Method according to one of the claims 1 or 2,
wherein said constants (c₁, c₂, c₃, c₄, c₅, c₆) are pre-generated by a calibration procedure and stored in a memory.

4. Method according to one of the claims 1 or 2,
wherein at least one of the constants (c₁, c₂, c₃, c₄, c₅, c₆) may be set or adjusted by an input device.

5. Method according to one of the preceding claims, wherein said value (PₑₓO₂) representing the partial pressure of O₂ in said exhaust gas is low pass filtered, reducing the effects of rapid fluctuations in the measured value.

6. Method according to one of the preceding claims, wherein said value (PₑₓO₂) is calculated as an average value of a number of recently measured values (PₑₓO₂) of partial pressure in said exhaust gas.

7. Method according to one of the preceding claims,
further comprising the step of
displaying the estimated value (PₐO₂) presenting the arterial partial pressure of O₂ on a display.

8. Method according to one of the preceding claims,
reiterated as a pseudo-continuous process until the receipt of a stop signal.

9. Method according to one of the preceding claims,
wherein c₃=0 and c₅=0, and wherein the correction value is also influenced by measurements of venous oxygen saturation and arterial haemoglobin concentration.

10. Method according to one of the preceding claims,
wherein the correction value is also influenced by at least one cross-term which is a product of two measurement values selected from the group [PₑₓO₂, Ta, q_{blood}, venous oxygene saturation, arterial haemoglobin concentration, FiO₂, q_{gas}]

11. Apparatus for estimating a value (PₐO₂) representing the arterial partial pressure of O₂ for a patient subject to extra corporeal circulation by means of an oxygenator, the apparatus comprising:
a measuring device for measuring a value (PₑₓO₂) representing the partial pressure of O₂ in the exhaust gas of the oxygenator, and
a processing device for calculating the estimated value (PₐO₂) of the arterial partial pressure of O₂ based on the measured value (PₑₓO₂) of the partial pressure of O₂ in the exhaust gas,
wherein said estimated value (PₐO₂) of the arterial partial pressure of O₂ is calculated the result of the equation
PₐO₂=PₑₓO₂−ΔPO₂ (1)
wherein ΔPO₂ is a correction value, being calculated as the result of the equation
ΔPO₂=c₁·PₑₓO₂+c₂Tₐ+c₃FiO₂+c₄q_{blood}+c₅q_{gas}+c₆ (2)
wherein
PₑₓO₂ is the measured value of partial pressure of O₂ in the exhaust gas of the oxygenator,
Tₐ is a temperature value representing arterial blood temperature,
FiO₂ is a value representing the fraction of oxygen in the gas supplied to the oxygenator,
q_{blood} is the blood flow through the oxygenator,
q_{gas} is the gas flow supplied to the oxygenator, and
c₁, c₂, c₃, c₄, c₅, c₆ are predetermined constants.

12. Apparatus according to claim 11,
wherein c₁<0, c₂>0, c₃≧0, C₄<0, c₅≧0and c₆<0

13. Apparatus according to one of the claims 11 or 12,
wherein said constants (c₁, c₂, c₃, c₄, c₅, c₆) are pre-generated by a calibration procedure and stored in a memory.

14. Apparatus according to one of the claims 11 or 12,
wherein at least one of the constants (c₁, c₂, c₃, c₄, c₅, c₆) may be set or adjusted by an input device.

15. Apparatus according to one of claims 11 to 14, wherein said value (PₑₓO₂) representing the partial pressure of O₂ in said exhaust gas is low pass filtered, reducing the effects of rapid fluctuations in the measured value.

16. Apparatus according to one of the claims 11 to 15, wherein said value (PₑₓO₂) is calculated as an average value of a number of recently measured values (PₑₓO₂) of partial pressure in said exhaust gas.

17. Apparatus according to one of the claims 11 to 16,
further comprising a display for displaying the estimated value (PₐO₂) presenting the arterial partial pressure of O₂.

18. Apparatus according to one of the claims 11 to 17,
said processing device being arranged to reiterate the calculating of PₐO₂ values pseudo-continuously until the receipt of a stop signal.

19. Apparatus according to one of the claims 11 to 18,
wherein c₃=0 and c₅=0, and wherein the processing device is configured for calculating the correction value also in dependency of measurements of venous oxygen saturation and arterial haemoglobin concentration.

20. Apparatus according to one of the claims 11 to 19,
wherein the processing device is configured for calculating the correction value also in dependency of at least one cross-term which is a product of two measurement values selected from the group [PₑₓO₂, Tₐ, q_{blood}, venous oxygene saturation, arterial haemoglobin concentration, FiO₂, q_{gas}]
